(19) United States
(12) Patent Application Publication
(10) Pub. No.: US 2018/0072085 A1
(43) Pub. Date: Mar. 15, 2018

(54) PAGE HOLDER AND PAGE TURNER

(71) Applicant: Casio Computer Co., Ltd., Tokyo (JP)

(72) Inventor: Naoto Imamura, Tokyo (JP)

(21) Appl. No.: 15/654,887

(22) Filed: Jul. 20, 2017

(30) Foreign Application Priority Data
Sep. 9, 2016 (JP) 2016-177026

(51) Int. Cl. B42D 9/04; H04N 1/00; A47B 23/04; A47B 23/06; A47B 97/02

(52) U.S. Cl. CPC B42D 9/04; H04N 1/00602; A47B 97/02; A47B 23/06; A47B 23/043

(57) ABSTRACT

When a page is conveyed from a sticking section, a catching section catches and brings the page to a page-turning end point by a vane section rubbing against a surface of the page. A regulation section is provided extending from a side of a roller cover to an area below vane sections, and regulates the movement of each vane section before a vane section strikes the page already fixed at the page-turning endpoint or strikes a holding plate. By being formed of an elastic member, each vane section is pulled into the roller cover while being greatly bent by the regulation section.

### CROSS-REFERENCE TO RELATED APPLICATION

This application is based upon and claims the benefit of priority from the prior Japanese Patent Application No. 2016-177026, filed Sep. 9, 2016, the entire contents of which are incorporated herein by reference.

### BACKGROUND OF THE INVENTION

### 1. Field of the Invention

The present invention relates to a page holder and a page turner.

### 2. Description of the Related Art

Conventionally, a page turner is known which turns overlapping pages one by one by sticking thereto (for example, refer to Japanese Patent Application Laid-Open (Kokai) Publication No. 2016-010907). This page turner includes a vane wheel that pulls in a page being turned over, on which a plurality of vane sections have been attached along the peripheral direction so as to catch pages. Each vane section is formed of a flexible plate-like member, and a material having a high frictional resistance has been provided on a side of its end portion which comes in contact with a page.

In the above-described conventional technology, when the vane wheel is rotated and the vane sections strike pages on a page-turning end side, a periodical pattering noise occurs.

### SUMMARY OF THE INVENTION

In accordance with one aspect of the present invention, there is provided a page holder which presses and holds a turned page of a book at a page-turning end point, comprising: a vane which catches and brings the page to the page-turning endpoint by rotating an elastic member; a regulator which regulates striking by the rotating vane against the page caught and brought to the page-turning end point.

In accordance with one aspect of the present invention, there is provided a page turner comprising: the above-described page holder.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The present invention can be more clearly understood by the detailed description below being considered together with the following drawings.

FIG. 1 is a perspective view showing a schematic structure of a page turner 1 according an embodiment;

FIG. 2 is a perspective view showing the external structure of a page holding section 7 according to the embodiment;

FIG. 3A and FIG. 3B are perspective and side views showing the structure of a catching section 751 according the embodiment;

FIG. 4A, FIG. 4B, and FIG. 4C are schematic views showing the structure of a roller cover 100 for vane sections 81 according the embodiment;

FIG. 5 is a schematic view showing a set state of a page holder 75 according the embodiment and a movement of the catching section 751; and

FIG. 6 is a schematic view showing states of the vane sections 81 in the roller cover 100 according the embodiment.

### DETAILED DESCRIPTION OF THE PREFERRED EMBODIMENT

A preferred embodiment of the present invention will hereinafter be described with reference to the accompanying drawings. Note that, although the embodiment described below is provided with various technically preferable limitations in order to carry out the present invention, these limitations are not intended to limit the scope of the present invention to the embodiment and examples shown in the drawings.

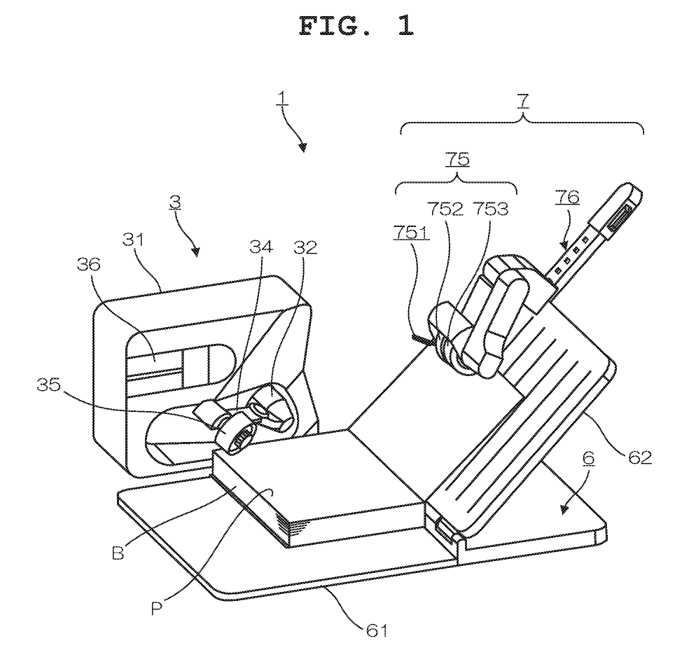

FIG. 1 is a perspective view showing a schematic structure of a page turner 1 according an embodiment. Note that in the following descriptions a case is exemplarily described in which pages P of a book B are turned from left to right.

This page turner 1 includes a page-turning section 3 which turns pages P of the book B, a holding table 6 on which the book B is set, and a page holding section 7 which holds pages P at a page-turning end point, as shown in FIG. 1. Note that, although omitted in the drawing, this page turner 1 also includes a stand section on which an information processing terminal (such as a smartphone or a tablet) having imaging means for photographing pages P of the book B is set.

The page-turning section 3 includes an accommodation case 31 having a substantially rectangular parallelepiped shape, a driving shaft 32 which is driven to be rotated by driving means such as a motor, an arm section 34 which swings around the driving shaft 32, a sticking section 35 which is attached to a distal end of the arm section 34 and sticks to a page P of the book B, an air blowing section 36 which blows air against a page P at a page-turning end point by making air pass above a page P at a page-turning start point, and a control section not shown which controls the respective sections.

The accommodation case 31 accommodates the driving shaft 32, the arm section 34, the sticking section 35, and the air blowing section 36. The main surface of the accommodation case 31 is provided with a first accommodation concave recess for accommodating the driving shaft 32, the arm section 34, and the sticking section 35, and a second accommodation concave recess for accommodating the air blowing section 36.

The holding table 6 includes a pair of holding plates 61 and 62 which is foldable by a hinge. In the case of the present embodiment in which pages P of the book B are turned from left to right, one holding plate 61 of the pair of holding plates 61 and 62 which is located on the left side is placed along the surface of a table, and the other holding plate 62 located on the right side is placed obliquely upward on the table at a predetermined tilt angle with respect to the holding plate 61. On the holding plate 61, Pages P that serve as page-turning start points of the book B are placed. On the other holding plate 62, pages P that serve as page-turning end points of the book B are placed.

Accordingly, the holding table 6 holds the book B such that the pages P on the page-turning end side tilt in a direction to rise with a seam b2 of the book B as an axis, as compared to the pages P on the page-turning start side. Note that, since the pair of holding plates 61 and 62 is foldable by the hinge, an angle between the pair of holding plates 61 and 62 can be adjusted and a tilt angle of a page P at a page-turning end point with respect to the horizontal plane can be freely adjusted. This tilt angle should preferably be adjusted in the range of 30° to 45°.

The page holding section 7 includes a page holder 75 and a positioning section 76. The page holder 75 includes a catching section 751, a pull-in roller 752, and a pressing roller 753. The catching section 751 catches and brings each page P to a page-turning end point so as to prevent it from returning to a page-turning start point. The pull-in roller 752 rotates coaxially with the catching section 751 and pulls in each page P conveyed by the sticking section 35 and caught by the catching section 751 so as to prevent it from returning to a page-turning start point. The pressing roller 753 presses and holds each page P at a page-turning end point.

The positioning section 76 adjusts the fixing position of the page holder 7 on the holding plate 62 in accordance with the size of the book B such that the roller surfaces of the pull-in roller 752 and the pressing roller 753 are placed on an edge portion of a page P turned and positioned at a page-turning end point, and fixes the page holder 7 on the holding plate 62.

In the above-described structure, when the driving shaft 32 is rotated, the arm section 34 reciprocates between a page-turning start point of pages P and a page-turning end point thereof as if it draws an arc centered on the driving shaft 32. In the following descriptions, a movement from a page-turning start point of pages P to a page-turning end point thereof is regarded as a forward movement, and a movement from a page-turning end point to a page-turning start point is regarded as a backward movement.

When the arm section 34 is moved forward by a page-turning operation, a page P at a page-turning start point which has been stuck to the sticking section 35 moves toward a page-turning end point along with this forward movement of the arm section 34.

Subsequently, when the page P stuck to the sticking section 35 approaches the page-turning end point by being conveyed, the page holder 75 catches this page P by the rotational movements of the vane sections (described later) of the catching section 751. Then, the page holder 75 pulls in the caught page P by the pull-in roller 752, and presses it by the pressing roller 753 so as to unfailingly hold it at the page-turning end point.

In the backward movement of the arm section 34, its travelling direction is reverse to the direction of the forward movement. Here, the sticking section 35 moves along the same path while being separated from the page P, and then sticks to a new page P at a page-turning start point. By this reciprocating operation being repeated, the operation of turning pages P is continued.

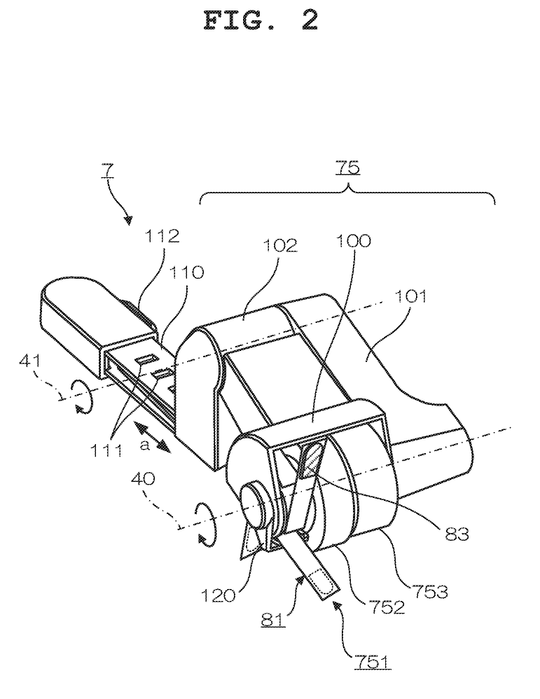

FIG. 2 is a perspective view showing the external structure of the page holding section 7 according to the embodiment, in which the catching section 751, the pull-in roller 752, and the pressing roller 753 constituting the page holder 75 have been coaxially arranged and covered by the roller cover 100. During a page-turning operation, driving force is applied to the catching section 751, the pull-in roller 752, and the pressing roller 753 such that they are rotated in the same direction around a rotation axis 40 that is driven by a motor not shown.

When a page P is conveyed from the sticking section 35, the catching section 751 catches and brings the page to a page-turning end point by a vane section 81 rubbing against a surface of the page P. On a surface of a distal end of each vane section 81 which comes in contact with a page P, a sheet member 83 formed of a material whose frictional resistance is higher than those of the pages P has been provided. Also, the roller cover 100 has a regulation section 120 removably attached thereto.

The regulation section 120 is provided extending from a side of the roller cover 100 to an area below the vane sections 81. This regulation section 120 regulates the movement of each vane section 81 before it strikes a page P already fixed at a page-turning end point (or strikes the holding plate 62). As a result, each vane section 81 is pulled into the roller cover 100 without striking a page P (or the holding plate 62). Here, by being formed of an elastic member, each vane section 81 is pulled into the roller cover 100 while being greatly bent by the regulation section 120. Then, by coming out of the roller cover 100, each vane section 81 returns to the original state by its elastic force.

The pull-in roller 752 is formed of a flexible sponge-like material whose diameter is smaller than that of the catching section 751 and larger than that of the pressing roller 753 when it is in the undeformed form. This pull-in roller 752 pulls in a page P caught by a vane section 81 of the catching section 751.

Here, since the diameter of the pull-in roller 752 is smaller than that of the catching section 751, the pull-in roller 752 can easily pull in the page P caught by the catching section 751. Also, when the pull-in roller 752 is in contact with the page P, the contacting portion has the same diameter as that of the pressing roller 753 by being deformed, by which the pull-in roller 752 does not apply any excessive pressing force to the page P.

The pressing roller 753 has a diameter smaller than that of the pull-in roller 752, and its surface is formed of a material (such as urethane rubber) whose friction coefficient with respect to the pages P is high. By having the diameter smaller than that of the pull-in roller 752, the pressing roller 753 can easily press and hold a page P pulled in by the pull-in roller 752 at a page-turning end point.

In the arm section 101, a motor for rotating the catching section 751, the pull-in roller 752, and the pressing roller 753 is mounted, which is not shown in the drawing. This motor, which receives power supply from the page-turning section 3 side through a predetermined cable (such as a USB cable) is controlled to be driven in conjunction with page-turning operations. Note that the pressing roller 753 is equipped with a torque limiter, and this torque limiter restricts the transmission torque of driving force so as to prevent the pressing roller 753 from continuously idling on a page P and damaging it.

Also, the arm section 101 is rotated around a rotation axis 41 located extending in a main body frame section 102 in accordance with the thickness of pages P on the page-turning end side. This arm section 101 can arrange the catching section 751, the pull-in roller 752, and the pressing roller 753 at optimal positions in the height direction. In other words, the roller cover 100 and the arm section 101 are connected to each other. By the arm section 101 being rotated with respect to the main body frame section 102, the entire roller cover 100 (the catching section 751, the pull-in roller 752, and the pressing roller 753) is rotated in conjunction therewith.

Moreover, the arm section 101 forces the catching section 751, the pull-in roller 752, and the pressing roller 753 toward a page P with a predetermined pressing force by forcing means not shown, such as a spring, and its self-weight. Note that the pressing force by this forcing means such as a spring can be adjusted in accordance with the size of the book B, the paper type, or the opening angle of the book B.

The main body frame section 102 is fixed to a slide rail 110 constituting the positioning section 76 in a manner to be movable in the directions of arrows “a”. In the slide rail 110, a plurality of rail grooves 111 are formed extending in the directions perpendicular to the arrow “a” directions at predetermined intervals. By a slider (not shown in the drawing) provided in the main body frame section 102 being fitted into one of the rail grooves 111, the page holder 75 is fixed at the position of this rail groove 111. A fixation switch 112 thereon is an operation unit for engaging or releasing the mechanism for fixing the page holding section 7 to the holding plate 62.

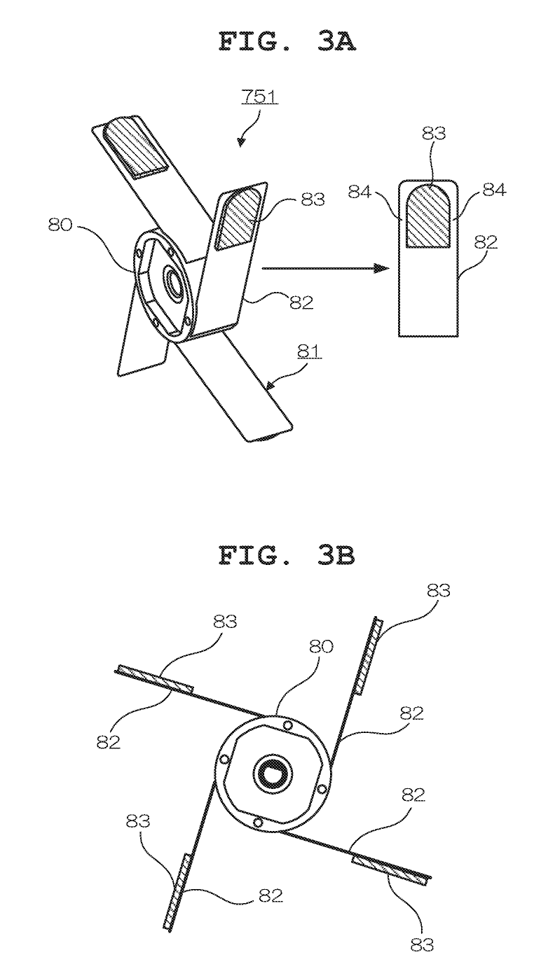

FIG. 3A and FIG. 3B are perspective and side views showing the structure of the catching section 751 according the present embodiment. The catching section 751 includes a cylindrical roller section 80 that is driven to be rotated by a motor not shown, and the plurality of vane sections 81 attached to the roller section 80 at predetermined intervals along the circumference of the roller section 80.

Each vane section 81 is constituted by a flexible plate-like member 82 (base member) made of a resin such as PET (Polyethylene Terephthalate), and the sheet member 83 provided on a surface of a distal end of the vane section 81 which comes in contact with a page P. Each plate-like member 82 is attached such that it extends along a tangent line to the roller section 80 when it is not under load, and each sheet member 83 is formed of a material whose frictional resistance with respect to the pages P is high and which is wear-resistant.

To both ends of each sheet member 83, empty spaces 84 are provided such that the plate-like member 82 thereunder is partially exposed. That is, by the width of the sheet member 83 being formed narrower than that of the plate-like member 82, the empty spaces are created to both ends of the sheet member 83.

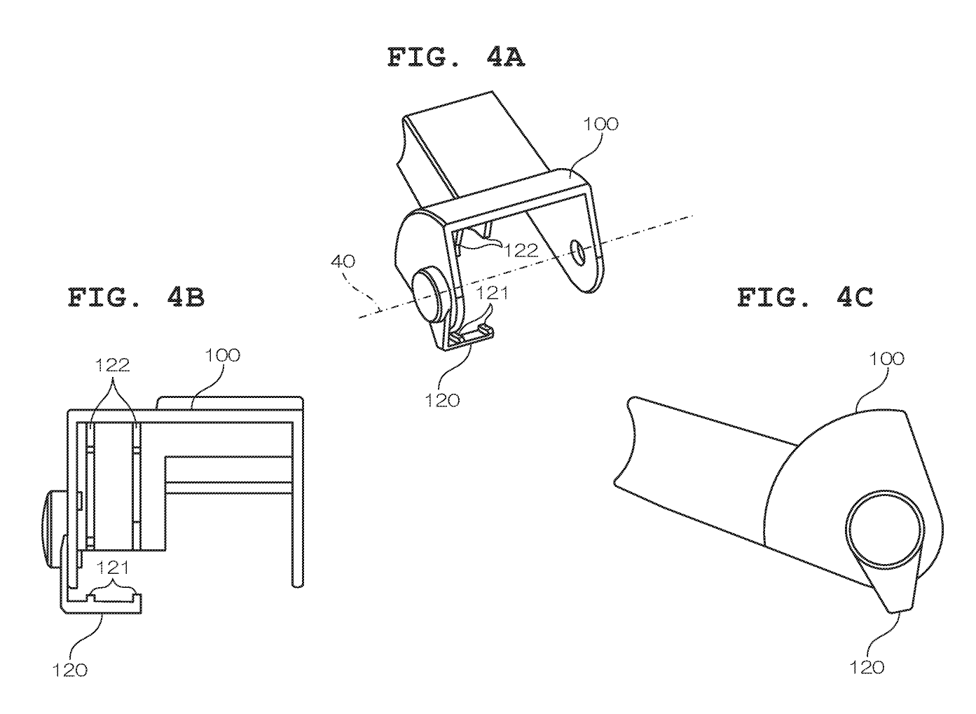

FIG. 4A, FIG. 4B, and FIG. 4C are schematic views showing the structure of the roller cover 100 for the vane sections 81 according the present embodiment. On the roller cover 100, the regulation section 120 for regulating the rotating vane sections 81 is provided in an area where the catching section 751 is mounted. On a portion of the inner side of this regulation section 120 with which the vane sections 81 come in contact, ribs 121 (projection portion) are formed in two rows. The length of the interval between these ribs 121 formed in two rows is substantially the same as that of the interval between the empty spaces 84 provided to the sides of each sheet member 83.

In a rotational movement, each vane section 81 is regulated by the regulation section 120 before striking a page P already fixed at a page-turning end point (or striking the holding plate 62), and then pulled into the roller cover 100 while being greatly bent by the elasticity of the plate-like member 82. As a result of this structure, each vane section 81 is prevented from striking a page P fixed at a page-turning end point, whereby the occurrence of a periodical pattering noise can be prevented (or reduced).

Also, when each vane section 81 is to be pulled into the roller cover 100, the empty spaces 84 positioned to both ends of the sheet member 83 come in contact with the ribs 121. As a result of this structure, the sheet members 83 do not directly come in contact with the inner surface of the regulation section 120 and therefore do not unnecessarily wear out, so that their life spans are not shortened. Note that a page P to be caught has a floating force and therefore its frictional force with respect to the sheet member 83 acts without it being pressed. As a result, the page P can be unfailingly caught.

Also, the roller cover 100 has a diameter larger than those of the pressing roller 753 and the pull-in roller 752, and a size by which the rotational trajectory of the distal end of each vane section 81 housed in the roller cover 100 is restricted to be a rotational trajectory having a smaller radius. Here, the rotational trajectory of the distal end of each rotating vane section 81 is larger than the diameters of the pressing roller 753 and the pull-in roller 752. That is, the inner periphery of the roller cover 100 is formed to have a size close to the outer periphery of the roller section 80 having the vane sections 81 such that it does not come in contact with the pressing roller 753 and the pull-in roller 752 and the vane sections 81 which rotate inside the roller cover 100 are deformable. As a result of this structure, the roller cover 100 can be formed smaller as much as possible without matching its size with the rotational trajectories of the distal ends of the vane sections 81.

On the inner surface of the roller cover 100 as well, ribs 122 are formed in two rows in an area that comes in contact with the vane sections 81, as in the case of the regulation section 120. The length of the interval between these ribs 122 formed in two rows is substantially the same as that of the interval between the empty spaces 84 provided to the sides of each sheet member 83, as in the case of the ribs 121. Accordingly, when the vane sections 81 housed in the roller cover 100 are rotating inside the roller cover 100, the sheet members 83 do not directly come in contact with the inner surface of the roller cover 100 by the ribs 122 coming in contact the empty spaces 84 provided to the sides of each sheet member 83, and therefore do not unnecessarily wear out, so that their life spans are not shortened.

In this embodiment, the regulation section 120 shown in FIG. 4A, FIG. 4B, and FIG. 4C is detachable from the roller cover 100. That is, the regulation section 120 and the roller cover 100 have separate bodies. However, the present invention is not limited to this structure where the regulation section 120 has a separate body, and the regulation section 120 and the roller cover 100 may be integrally formed. That is, the “regulation section” herein may be the regulation section 120 alone or may be the entire roller cover 100 including the regulation section 120.

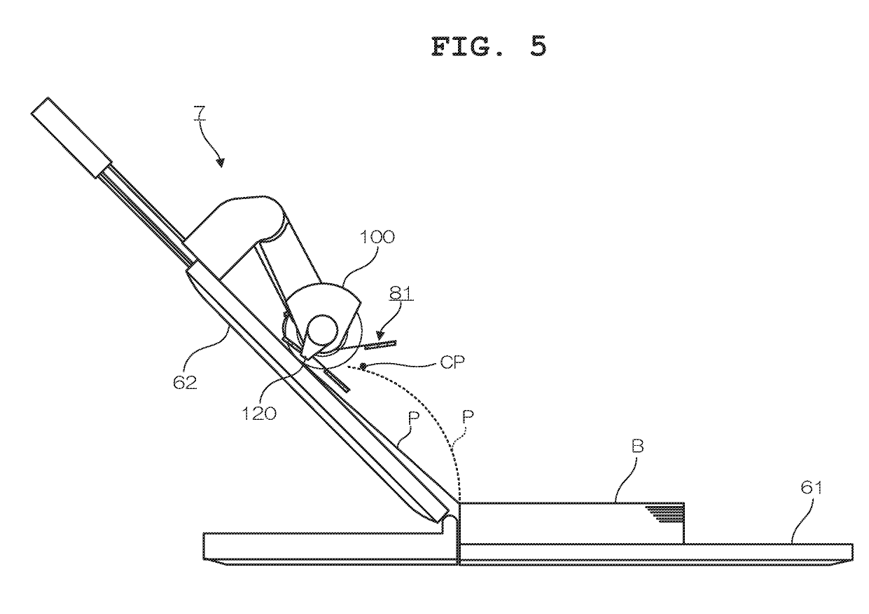

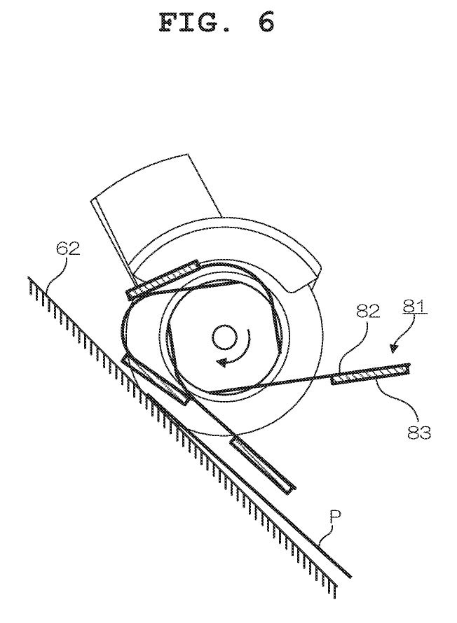

FIG. 5 is a schematic view showing a set state of the page holder 75 according the present embodiment and a movement of the catching section 751, and FIG. 6 is a schematic view showing states of the vane sections 81 in the roller cover 100 according the present embodiment.

Here, the page holder 75 has been fixed to an appropriate portion of the holding plate 62 by the slide rail 110 being adjusted. When a page P stuck to the sticking section 35 is moved toward a page-turning end point along with a forward movement of the arm section 34, a rotating vane section 81 (sheet member 83) and the turned page P come in contact with each other at a point CP located slightly above the page-turning end point or a point nearby.

The page P, which has come in contact with the vane section 81 (sheet member 83), is pulled in by the rotating operation of the vane section 81, further pulled in by the pull-in roller 752 and the pressing roller 753, and then fixed at the page-turning end point. Here, when the page P is pulled in by the pull-in roller 752 and the pressing roller 753, the ribs 121 (refer to FIG. 4A and FIG. 4B) of the regulation section 120 come in contact with the empty spaces 84 provided to both ends of the sheet member 83 before the vane section 81 strikes this page P (holding plate 62), and then the vane section 81 is pulled into the roller cover 100 while being bent along the ribs 121 by the elasticity of the plate-like member 82.

In the roller cover 100 as well, by the ribs 122 shown in FIG. 4A and FIG. 4B coming in contact with the empty spaces 84 provided to both ends of the sheet member 83, the vane section 81 is rotated while being bent along the ribs 121 by the elasticity of the plate-like member 82. Here, since the ribs 122 are in contact with the empty spaces 84 provided to both ends of the sheet member 83, the sheet member 83 does not directly come in contact with the inner surface of the roller cover 100. When the vane section 81 passes the ribs 122, it is released from being bent by the elasticity of the plate-like member 82. That is, by coming out of the roller cover 100, the vane section 81 returns to the original state.

According to the above-described embodiment, the vane sections 81, which catch and bring pages P to page-turning end points by rotating their plate-like members 82 formed of elastic members, are regulated by the regulation section 120 so that striking thereby against the pages P caught and brought to the page-turning end points is regulated. As a result of this structure, each vane section 81 is prevented from striking a page P fixed at a page-turning end point, whereby the occurrence of a periodical pattering noise can be prevented.

Also, according to the above-described embodiment, the rotational trajectory of the distal end of each vane section 81 is regulated by the regulation section 120 so as to be a rotational trajectory having a smaller radius. As a result of this structure, each vane section 81 is prevented from striking a page P fixed at a page-turning end point, whereby the occurrence of a periodical pattering noise can be prevented.

Moreover, according to the above-described embodiment, striking by each rotating vane section 81 is regulated by the roller cover 100 which is at least partially covering these vane sections 81. As a result of this structure, the roller cover 100 can be formed smaller as much as possible without matching its size with the rotational trajectories of the distal ends of the vane sections 81.

Furthermore, according to the above-described embodiment, striking by the rotating vane sections 81 is regulated by the regulation section 120 arranged at a point where a vane section 81 which has caught and brought a page P to a page-turning end point is pulled into the roller cover 100. As a result of this structure, each vane section 81 is prevented from striking a page P fixed at a page-turning end point, whereby the occurrence of a periodical pattering noise can be prevented.

Still further, according to the above-described embodiment, each vane section 81 is constituted by the plate-like member 82 formed of an elastic member, and the sheet member 83 which is formed of a friction member, provided to come in contact with a page P, and has the empty spaces 84 where portions of the distal end of the plate-like member 82 are exposed. In addition, the regulation section 120 is provided with the ribs 121 which come in contact with the exposed portions of the plate-like member 82 when the rotating vain section is pulled in. Asa result of this structure, the sheet members 83 do not directly come in contact with the inner surface of the regulation section 120 and therefore do not unnecessarily wear out, so that their life spans are not shortened.

Yet still further, according to the above-described embodiment, the empty spaces 84 are formed to both sides of each sheet member 83, or may be formed on the inner side. As a result of this structure, the sheet members 83 do not directly come in contact with the inner surfaces of the regulation section 120 and the roller cover 100 and therefore do not unnecessarily wear out, so that their life spans are not shortened.

In the above-described embodiment, the example has been described in which the empty spaces 84 are formed to both sides of each sheet member 83. However, a structure may be adopted in which the sheet member 83 is divided into two portions, an empty space is formed in the middle thereof, and a rib (projection portion) corresponding to the empty space is formed on the roller cover 100 and the regulation section 120.

Also, in the above-described embodiment, the structure having the plurality of vane sections has been described as a preferred example. However, a structure having one vane section may be adopted.

Moreover, in the above-described embodiment, the vane sections 81 are constituted by the flexible plate-like members 82. However, a structure may be adopted in which resilient metal wires having a loop shape similarly functions as the vanes. In this structure, the area of each vane section is less than that of the above-described embodiment, and therefore an effect that the vane sections 81 make less noise can be obtained.

While the present invention has been described with reference to the preferred embodiments, it is intended that the invention be not limited by any of the details of the description therein but includes all the embodiments which fall within the scope of the appended claims.

What is claimed is:

1. A page holder which presses and holds a turned page of a book at a page-turning end point, comprising:
a vane which catches and brings the page to the page-turning end point by rotating an elastic member;
a regulator which regulates striking by the rotating vane against the page caught and brought to the page-turning end point.

2. The page holder according to claim 1, wherein the regulator regulates such that a rotational trajectory of a distal end of the vane that has caught and brought the page to the page-turning end point is restricted to be a rotational trajectory having a smaller radius.

3. The page holder according to claim 1, wherein the regulator is a cover which at least partially covers the vane.

4. The page holder according to claim 1, wherein the vane has a base member constituted by an elastic member, and a friction member which has an empty space where a portion of a distal end of the base member is exposed and which is provided in a manner to come in contact with the page, and
wherein the regulator has a projection portion which comes in contact with the base member partially exposed from the friction member when the rotating vane is caught.

5. The page holder according to claim 4, wherein the friction member is structured such that empty spaces where the base member is partially exposed are formed to both sides of the friction member, and
wherein the projection portion is provided on areas corresponding to positions of the empty spaces.

6. The page holder according to claim 4, wherein the friction member is structured such that an empty space where the base member is partially exposed is formed in a middle portion of the friction member, and
wherein the projection portion is provided on an area corresponding to a position of the empty space.

7. The page holder according to claim 1, further comprising:
a cover which at least partially covers the vane,
wherein the regulator is arranged at a point where the vane that has caught and brought the page to the page-turning end point is pulled into the cover.

8. The page holder according to claim 7, wherein the vane has a base member constituted by an elastic member, and a friction member which has an empty space where a portion of a distal end of the base member is exposed and which is provided in a manner to come in contact with the page, and
wherein the regulator has a projection portion which comes in contact with the base member partially exposed from the friction member when the rotating vane is caught.

9. The page holder according to claim 8, wherein the friction member is structured such that empty spaces where the base member is partially exposed are formed to both sides of the friction member, and
wherein the projection portion is provided on areas corresponding to positions of the empty spaces.

10. The page holder according to claim 8, wherein the friction member is structured such that an empty space where the base member is partially exposed is formed in a middle portion of the friction member, and
wherein the projection portion is provided on an area corresponding to a position of the empty space.

11. A page turner comprising:
the page holder according to claim 1.
